(19) United States
(12) Patent Application Publication
(10) Pub. No.: US 2013/0130218 A1
(43) Pub. Date: May 23, 2013

(54) Application for Remote Administration and Scoring of NIHSS on Mobile Devices

(71) Applicant: Jaret James Hargreaves, Calgary (CA)

(72) Inventor: Jaret James Hargreaves, Calgary (CA)

(21) Appl. No.: 13/303,803

(22) Filed: Nov. 23, 2011

(51) Int. Cl. G09B 7/00

(52) U.S. Cl. 434/362

(57) ABSTRACT

Systems and methods for remotely administering and scoring a scored diagnostic test on a mobile device including a graphical display. In accordance with the methods, a scoring component of the scored diagnostic test is provided to the graphical display of the mobile device. The scoring component instructs a remote healthcare professional to measure and document different aspects of the scored diagnostic test. Further, a video component of the scored diagnostic test is provided on the graphical display of the mobile device. The video component allows the remote healthcare professional to view a patient while remotely administering the scored diagnostic test.

### BACKGROUND

Stroke is a sudden loss of brain function caused by interruption or loss of blood flow to the brain (ischemic stroke) or rupture of blood vessels in the brain (hemorrhagic stroke) that results in injury or death of brain tissue. The effects of stroke depend on where the brain was injured, as well as how much damage occurred. Correct diagnosis and timely treatment is crucial to patient outcome, particularly with respect to the limited time window to begin thrombolytic therapy in acute ischemic stroke patients. The National Institutes of Health Stroke Scale (NIHSS) is a standardized method for physicians and other health care professionals to measure the impairment of stroke, and thereby guide treatment decisions. Further, the NIHSS provides an objective comparison of efficacy across different stroke treatments and rehabilitation interventions. The NIHSS measures thirteen aspects of brain function, including consciousness, vision, sensation, movement, speech and language. A certain number of points are scored as each item is tested during a focused neurological examination. Administration of the NIHSS must be administered by a trained and certified healthcare professional according to a strict protocol.

While the NIHSS has proven to be a valid and reliable measure of stroke severity, implementation of the NIHSS in diagnosis and treatment of stroke requires that a healthcare professional with specialist stroke training be bedside or have access to video conferencing telemedicine technology (“telestroke”). Telestroke has helped enable healthcare professionals to virtually consult patients in remote and underserved communities. Using currently available telestroke technology, the healthcare professional typically receives a consult request on a handheld device such as a cellular smart phone. However, one problem with current telestroke is that the healthcare professional must then access a fixed workstation or personal computer in order to implement the NIHSS. Thus, the time required to implement the NIHSS (i.e., measure the impairment of stroke) may increase if the healthcare professional is unable to access the fixed workstation or personal computer.

### SUMMARY

Disclosed herein are methods and systems for remotely administering a scored diagnostic test on a mobile device with a graphical display. In one implementation, a scoring component is provided to the graphical display of the mobile device. For example, the scoring component may include a plurality of scoring factors associated with the scored diagnostic test. In addition, a video component is provided to the graphical display of the mobile device. The video component may be a real-time or recorded video stream of a patient.

The above implementation integrates a scoring component for instructing and documenting the scored diagnostic test with a video component for remote administration of the scored diagnostic test. In other words, this implementation provides a complete tool for remotely administering and scoring the scored diagnostic test on a mobile device. Thus, it is possible to reduce the amount of time required for the healthcare professional to implement the scored diagnostic test.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a simplified block diagram illustrating a system for remote administration and scoring of a scored diagnostic test;

FIG. 2 is a simplified block diagram illustrating a system for providing remote access to an application at a remote device via a computer network;

FIG. 3 is a state model in accordance with the present disclosure;

FIG. 4 illustrates aspects of the distributed system as applied to the system of FIG. 2;

FIG. 5 illustrates an exemplary operational flow diagram of a process to remotely administer and score a stroke scale;

FIG. 6 illustrates an exemplary handheld device;

FIG. 7 illustrates an exemplary graphical display of a handheld device;

FIG. 8 illustrates a second exemplary graphical display of a handheld device;

FIG. 9 illustrates a third exemplary graphical display of a handheld device;

FIG. 10 illustrates a fourth exemplary graphical display of a handheld device;

FIG. 11 illustrates an exemplary operational flow diagram of the NIHSS; and

FIG. 12 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely administering stroke scales, it will become evident to those skilled in the art that the implementations are not limited thereto, but are applicable for remotely administering and scoring any type of observation-dependent diagnostic test via a remote device, e.g., other neurological scoring such as coma scoring, and psychological scoring.

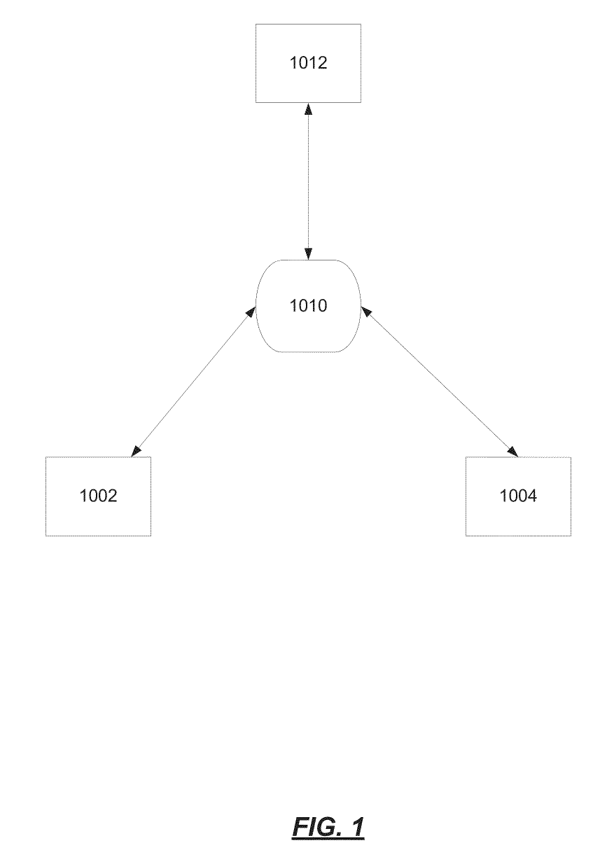

FIG. 1 is a simplified block diagram of a system for remote administration and scoring of a scored diagnostic test on a mobile device where the testing includes a separately provided video component. The system includes a mobile device 1012, such as a wireless handheld device (i.e., a cellular smart phone), a patient video capturing device 1004 and a server 1002, which are all connected via a communication network 1010. In the system shown in FIG. 1, a diagnostic test application may run on any device, including the mobile device 1012. In addition, the patient video capturing device 1004 may be any device capable of capturing video, such as a video camera, a camera on a computer or mobile device, a robotically controlled camera in a medical facility, etc. The server 1002 may be a video streaming server, an application server, a web server, etc. In the environment of FIG. 1, video may be streamed from the patient's location using the patient video capturing device 1004 or from the server 1002 through the communication network 1010 to the mobile device 1012.

In accordance with some implementations, the video is provided to the mobile device 1012 during the administration of the diagnostic test in a user interface of the mobile device 1012 that presents both the diagnostic test and the patient video. Therefore, FIG. 1 provides an environment where the diagnostic test application and video can be concurrently administered and displayed, respectively, on the mobile device 1012 over the connections to the communication network 1010.

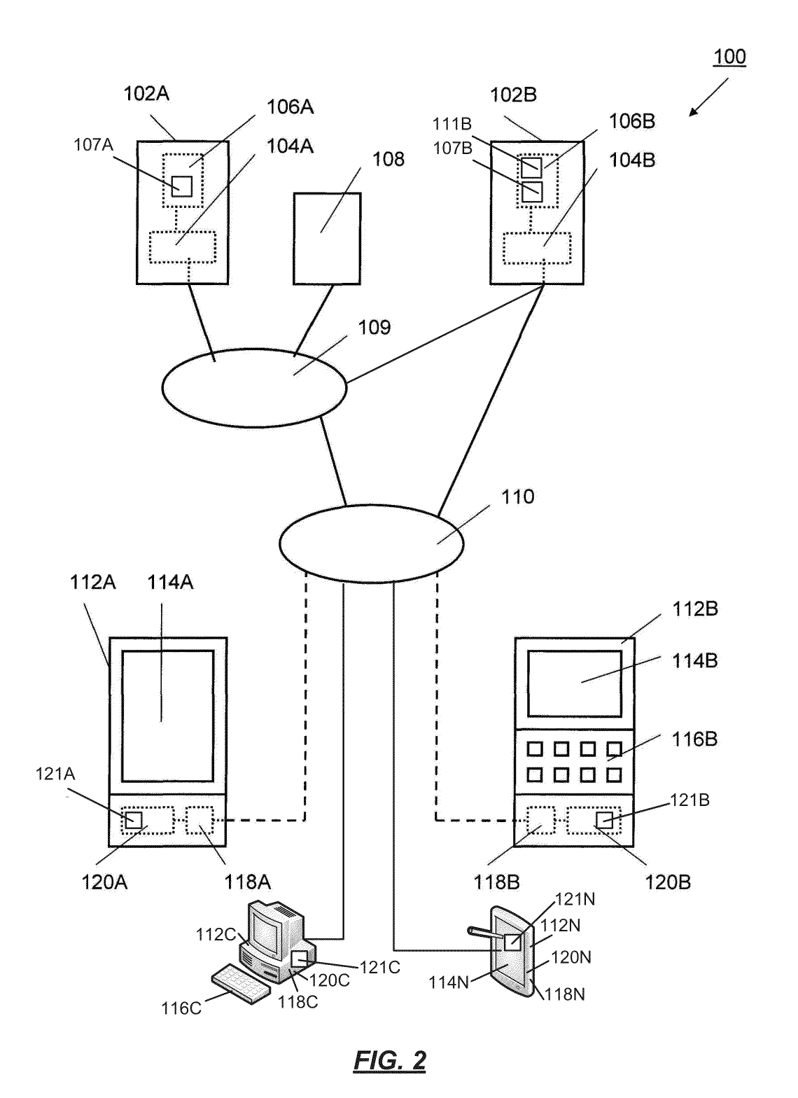

Referring to FIG. 2, a system 100 for providing remote access to an application, data or other service via a computer network. The system comprises a client computer 112A or 112B, such as a wireless handheld device such as, for example, an IPHONE 112A or a BLACKBERRY 112B connected via a computer network 110 such as, for example, the Internet, to a server 102B. Similarly, the client computing devices may also include a desktop/notebook personal computer 112C or a tablet device 112N that are connected by the communication network 110 to the server 102B. It is noted that the connections to the communication network 110 may be any type of connection, for example, Wi-Fi (IEEE 802.11x), WiMax (IEEE 802.16), Ethernet, 3G, 4G, etc.

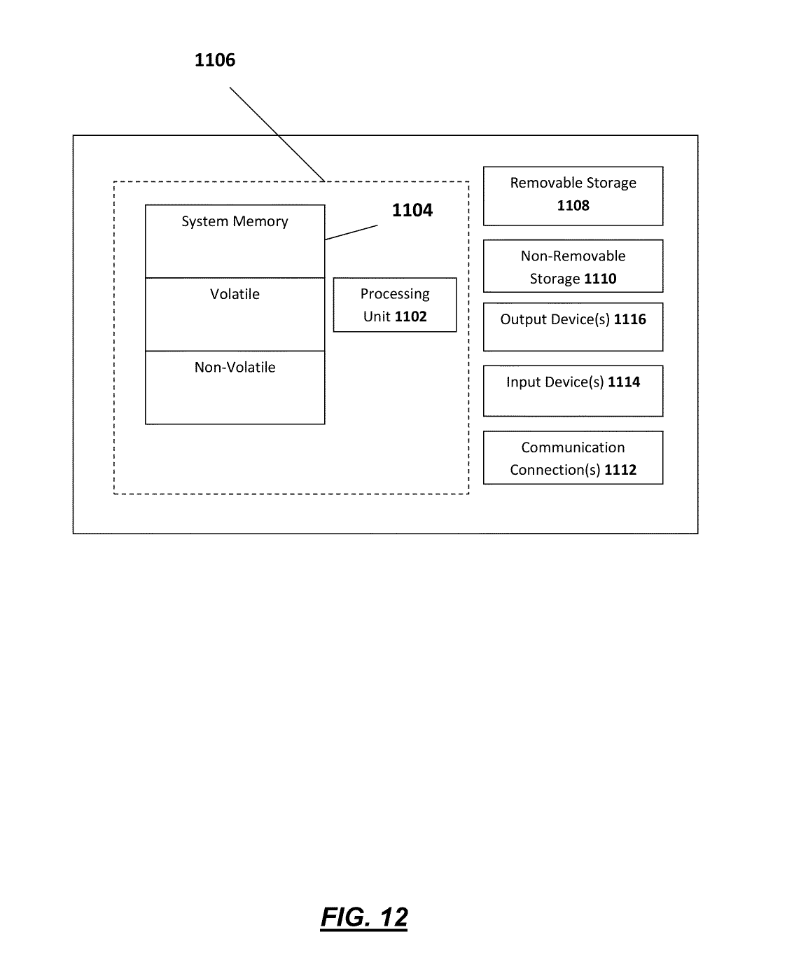

The server 102B is connected, for example, via the computer network 110 to a Local Area Network (LAN) 109 or may be directly connected to the computer network 110. For example, the LAN 109 is an internal computer network of an institution such as a hospital, a bank, a large business, or a government department. Typically, such institutions still use a mainframe computer 102A and a database 108 connected to the LAN 109. Numerous application programs 107A may be stored in memory 106A of the mainframe computer 102A and executed on a processor 104A. Similarly, numerous application programs 107B may be stored in memory 106B of the server 102B and executed on a processor 104B. The application programs 107A and 107B may be “services” offered for remote access. The mainframe computer 102A, the server 102B and the client computing devices 112A, 112B, 112C or 112N may be implemented using hardware such as that shown in the general purpose computing device of FIG. 12.

In some implementations, the application tier and server tier may be implemented within a cloud computing environment to provide remote access to the application programs 107A/107B. Cloud computing is a model for enabling network access to a shared pool of configurable computing resources (e.g., networks, servers, storage, applications, and services) that can be provisioned and released with minimal interaction. The cloud computing model promotes high availability, on-demand self-services, broad network access, resource pooling and rapid elasticity. In such an environment, the application programs 107A/107B may be accessed by the client computing devices 112A, 112B, 112C or 112N through a client interface, such as a client remote access application 121A, 121B, 121C, 121N, as described below.

As will be described, each of the client computing devices 112A, 112B, 112C or 112N may have different physical requirements and capabilities, however, the system 100 enables the delivery of an experience to each of the client computing devices 112A, 112B, 112C or 112N that is appropriate for the particular device and yet common to all devices.

The client remote access application 121A, 121B, 121C, 121N may be designed for providing user interaction for displaying data and/or imagery in a human comprehensible fashion and for determining user input data in dependence upon received user instructions for interacting with the application program using, for example, a graphical display with touch-screen 114A or a graphical display 114B/114N and a keyboard 116B/116C of the client computing devices 112A, 112B, 112C, 112N, respectively. For example, the client remote access application is performed by executing executable commands on processor 118A, 118B, 118C, 118N with the commands being stored in memory 120A, 120B, 120C, 120N of the client computer 112A, 112B, 112C, 112N, respectively.

Alternatively or additionally, a graphical display program is executed on the server 102B (as one of application programs 107B) which is then accessed via an URL by a generic client application such as, for example, a web browser executed on the client computer 112A, 112B. The graphical display is implemented using, for example, the native framework for mobile devices or, e.g., SILVERLIGHT for desktop devices. In some implementations, the server 102B may participate in a collaborative session with the client computing devices 112A, 112B, 112C . . . 112N. For example, the aforementioned one of the application programs 107B may enable the server 102B to collaboratively interact with the application program 107A or another application program 107B and the client remote access applications 121A, 121B, 121C, 121N. As such, the server 102B and each of the participating client computing devices 112A, 112B, 112C . . . 112N may present a synchronized view of the display of the application program.

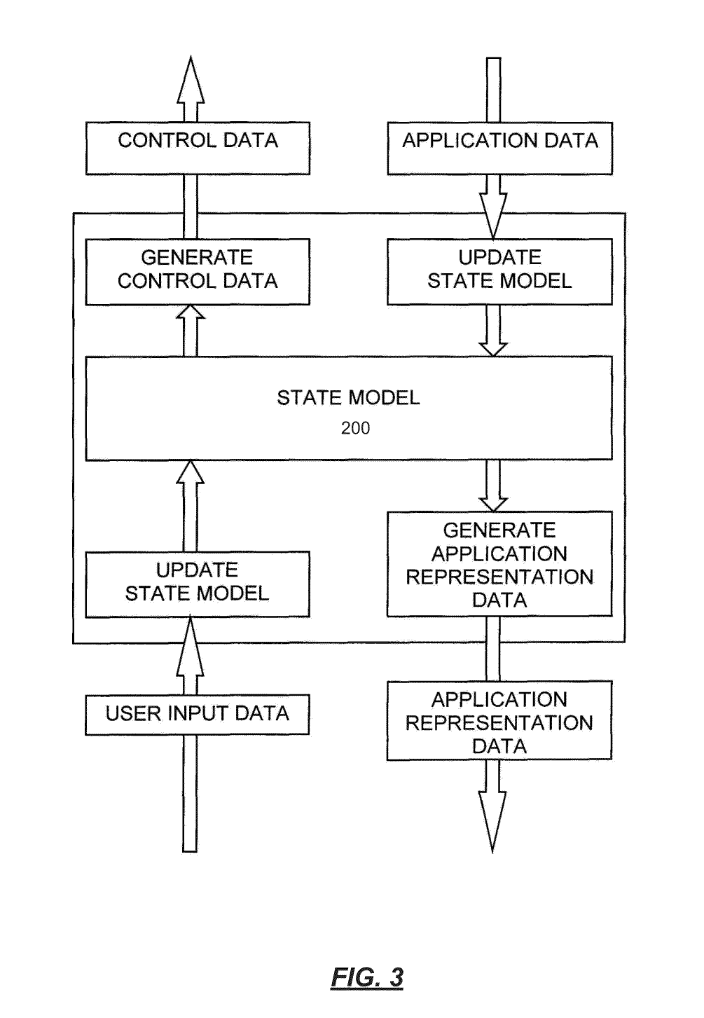

The operation of a server remote access application 111B with the client remote access application (any of 121A, 121B, 121C, 121N, or one of application programs 107B) is performed in cooperation with a state model 200, as illustrated in FIG. 3. An example of the server remote access application is PUREWEB, available from Calgary Scientific, Alberta, Canada. When executed, the client remote access application updates the state model 200 in accordance with user input data received from a user interface program. The remote access application may generate control data in accordance with the updated state model 200, and provide the same to the server remote access application 111B running on the server 102B.

Upon receipt of application data from an application program 107A or 107B, the server remote access application 111B updates the state model 200 in accordance with the screen or application data, generates presentation data in accordance with the updated state model 200, and provides the same to the client remote access application 121A, 121B, 121C, 121N on the client computing device. The state model 200 comprises an association of logical elements of the application program with corresponding states of the application program, with the logical elements being in a hierarchical order. For example, the logical elements may be a screen, a menu, a submenu, a button, etc. that make up the application program user interface. This enables the client device, for example, to natively display the logical elements. As such, a menu of the application program that is presented on a mobile phone will look like a native menu of the mobile phone. Similarly, the menu of the application program that is presented on desktop computer will look like a native menu of the desktop computer operating system.

The state model 200 is determined such that each of the logical elements is associated with a corresponding state of the application program 107A or 107B. The state model 200 may be determined such that the logical elements are associated with user interactions. For example, the logical elements of the application program are determined such that the logical elements comprise transition elements with each transition element relating a change of the state model 200 to one of control data and application representation data associated therewith.

The state model 200 may be represented in, e.g., an Extensible Markup Language (XML) document. Other representations of the state model are possible. Information regarding the application program is communicated in the state model. The state model 200 may thus contain session information about the application itself, an application extension, information about views, and how to tie the functionality of the application to the specific views.

In some implementations, two or more of the client computing devices 112A, 112B, 112C . . . 112N and/or the server 102B may collaboratively interact with the application program 107A or 107B. As such, by communicating state information between each of the client computing devices 112A, 112B, 112C . . . 112N and/or the server 102B and/or the mainframe computer 102A participating in a collaborative session, each of the participating client computing devices 112A, 112B, 112C . . . 112N may present a synchronized view of the display of the application program 107A or 107B.

In accordance with some implementations, the system 100 may provide for application extensions. Such extensions are provided as part of either the server remote access application 111B, the client remote access applications 121A, 121B, 121C, 121N, or both to provide features and functionalities that are otherwise are not provided by the application programs 107A or 107B. These features and functionalities may be provided without a need to modify the application programs 107A or 107B, as they are integral with the remote access applications.

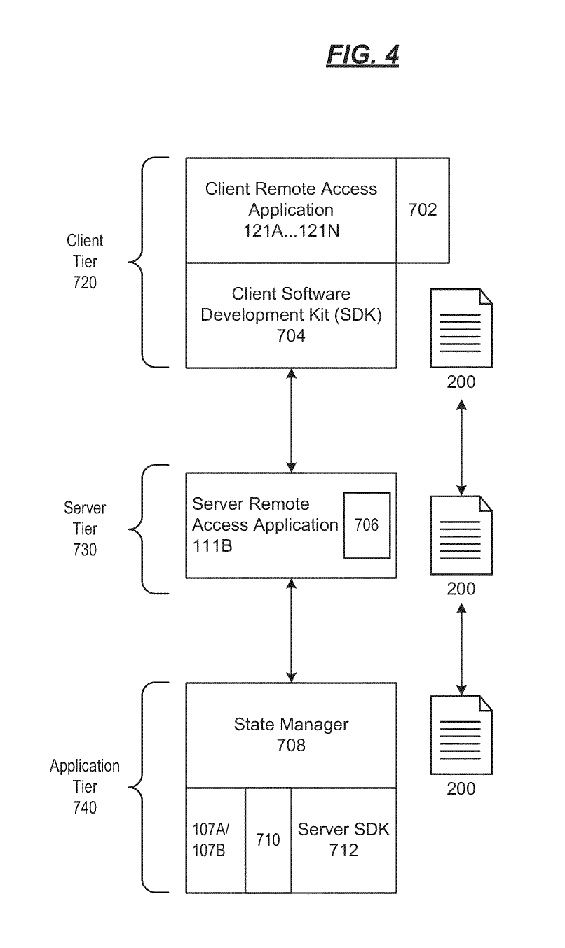

FIG. 4 illustrates aspects of the system 100 of FIG. 2 in greater detail. FIG. 4 illustrates the system 100 as having a tiered software stack. The client remote access application 121A, 121B, 121C, 121N may sit on top of a client software development kit (SDK) 704 in a client tier 720. The client tier 720 communicates to the server remote access application 111B in a server tier 730. The server tier 730 communicates to a state manager 708 sitting on top of the applications 107A/107B and a server SDK 712 in an application tier 740. In accordance with some implementations, application extensions may be implemented in any of the tiers, i.e., within the server tier 730 as a plug-in 706, the client tier 720 as client application extension 702, the application tier 740 as application extension 710, or combinations thereof. The state model 200 is communicated among the tiers and may be modified in any of the tiers by the application extensions 702 and 710, the plug-in 706, the client remote access applications 121A . . . 121N, the server remote access application 111B, and the applications 107A/107B to update/create session information contained therein.

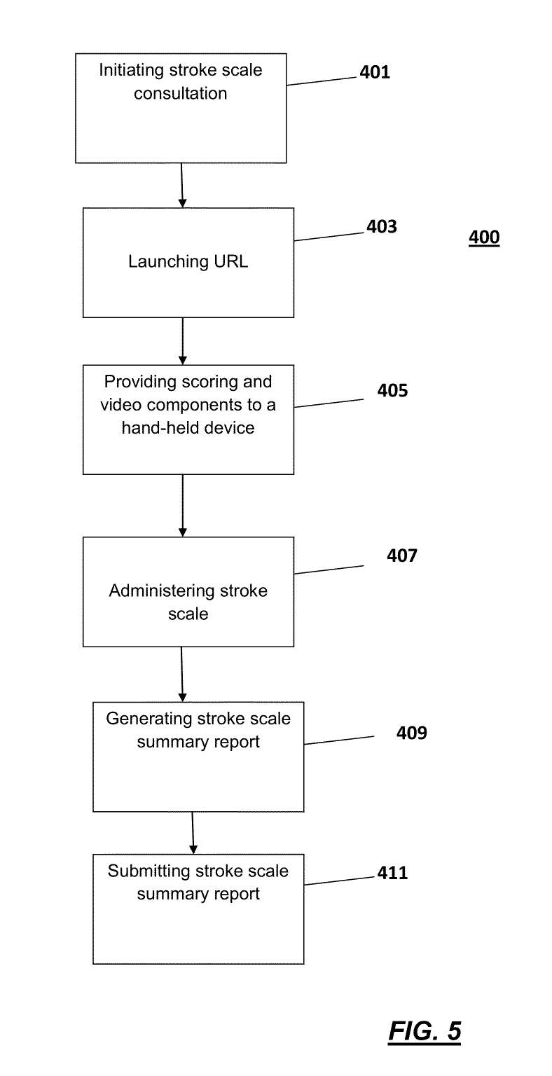

FIG. 5 illustrates an exemplary operational flow 400 of a process for remotely administering and scoring a stroke scale using a system providing remote access to an application. At 401, a collaborative consultation may be initiated by any means that provides video conferencing in conjunction with the server remote access application 111B such as, for example, a camera, application, etc. A bedside attendant initiates the collaborative consultation by sending a URL that identifies the collaborative session in an email, SMS message, etc., which is received by the healthcare professional on a client computing device 112A, 112B, 112C or 112N. As discussed above, the client computing device may be a handheld device. The message may contain a URL to the collaborative session, for example. At 403, the remote healthcare professional launches the URL using a generic application such as, for example, a web browser or an application executed on the client computing device 112A, 112B, 112C or 112N. The remote connection may be provided on a virtual private network (VPN), or encrypted for enhanced security. In addition, the collaborative consultation may be recorded, automatically or by request, at the start of the consultation for future reference, including by time shift recording (e.g., by a recording). In the event that the consultation is recorded, the healthcare professional may rewind the recording and review the video again before scoring.

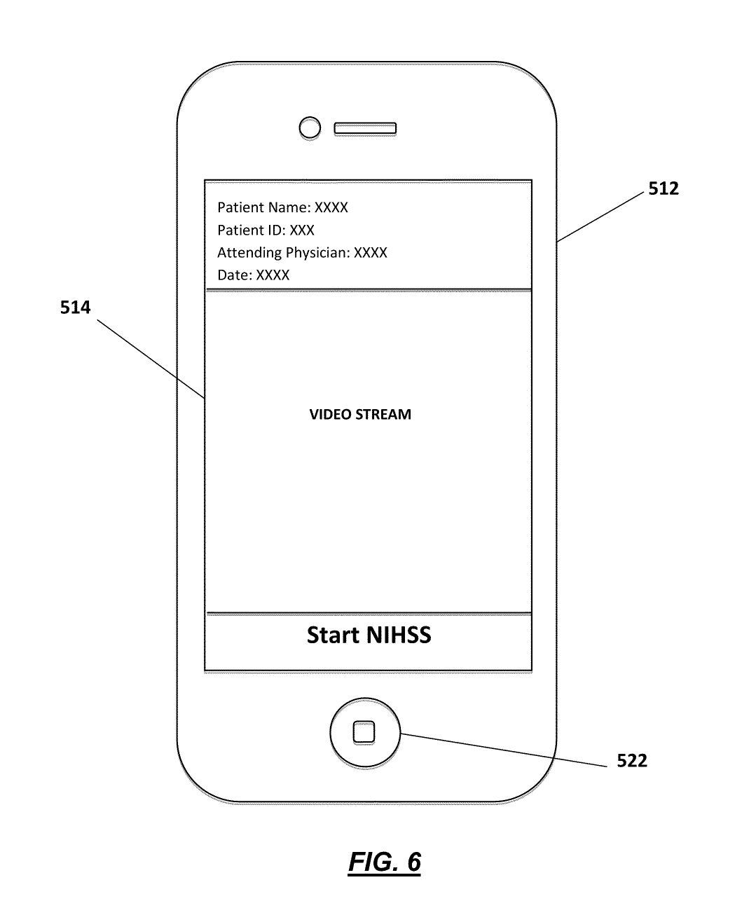

At 405, a scoring component and a video component are provided to the client computing device 112A, 112B, 112C or 112N and displayed on the graphical display 114A, 114B or 114N. For example, the scoring component presents a series of instructions prompting the remote healthcare professional to measure and document different aspects of brain function, and the video component presents either a real-time or a recorded video stream of the patient. In some implementations, the scoring component and the video component are displayed concurrently on the graphical display 114A, 114B or 114N. The scoring component and the video component are discussed in detail below with reference to FIGS. 6-9. At 407, the remote healthcare professional administers the stroke scale. During administration of the stroke scale, each item of the stroke scale is sequentially presented to the remote healthcare professional on the graphical display, and preferably concurrently with the video component. Before proceeding to a subsequent item in the stroke scale, the healthcare professional may be required to confirm the score for the current stroke scale item.

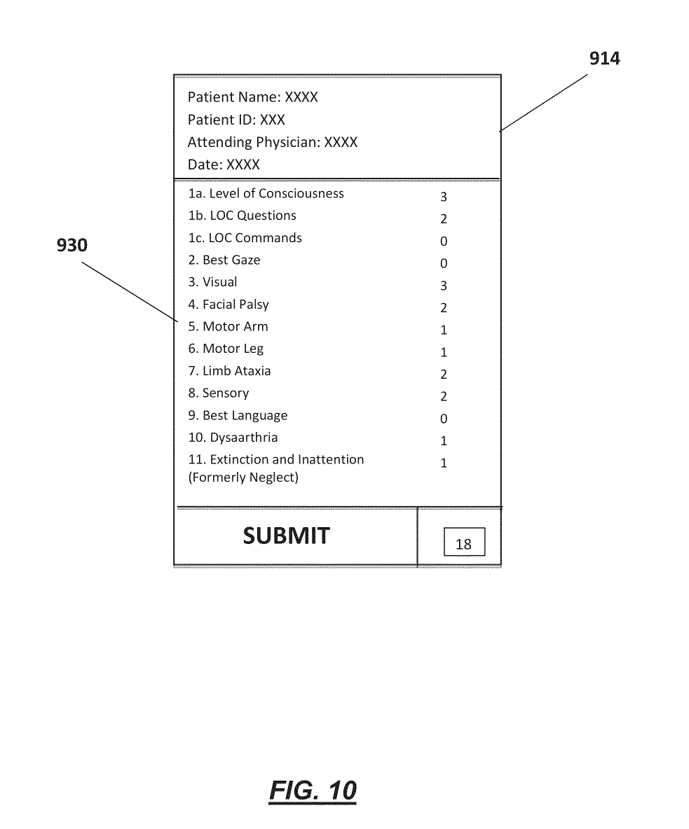

At 409, a summary report including the final stroke scale score may be automatically generated, for example. At 411, the remote healthcare professional submits the summary report for automatic recording and billing. The summary report and submission are discussed below with reference to FIG. 10.

Thus, as described above, the operational flow 400 provides a mechanism for remotely administering and scoring a stroke scale. Particularly, it is possible to implement the stroke scale entirely on a handheld device, for example. Accordingly, it may be possible to reduce the time needed for measurement of the impairment of stroke, which benefits patient outcome.

FIG. 6 illustrates an exemplary handheld device 512, which is one example of a client computing device 112A, 112B, 112C or 112N. The handheld device 512 may include a graphical display 514 and user-operated controls 522, for example.

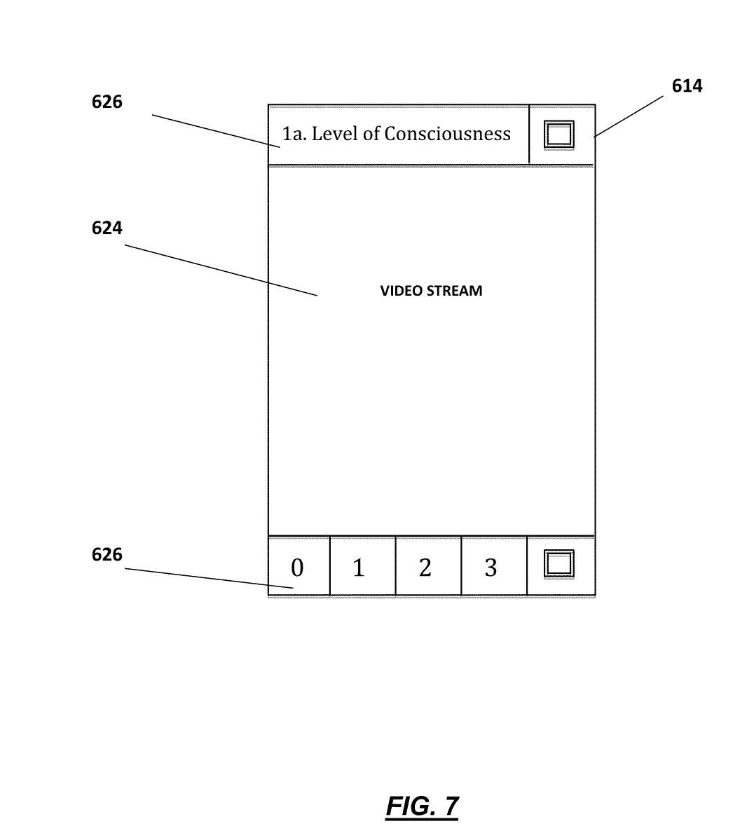

FIG. 7 illustrates an exemplary graphical display 614 of a handheld device. The graphical display includes a video component 624 and a scoring component 626. As discussed above, the video component 624 is either a real-time or a recorded video stream. The real-time video stream can be generated from any suitable source, such as, for example, a video camera, a camera on a computer or mobile device, a robotically-controlled camera in a medical facility, etc. Alternatively, the recorded video stream may be used, e.g., for training purposes, quality control and situations where immediate access to a trained healthcare professional is difficult (i.e., in a developing country). In one implementation, the video stream is connected to the server 102B, and the server remote access application 111B updates the state model 200 in accordance with the video stream and generates presentation data in accordance with the updated state model 200. The updated state model 200 is then provided to the client remote access application 121A, 121B, 121C or 121N on the client computing device 112A, 112B, 112C or 112N.

In addition to the video component 624, the graphical display 614 includes a scoring component 626 providing a series of instructions prompting the remote healthcare professional to measure and document different aspects of brain function. For example, as shown in FIG. 7, the scoring component 626 includes an instruction indicating the aspect of brain function being measured (i.e., “1a. Level of Consciousness”) and a means for documenting the results (“i.e., 0, 1, 2 or 3”). Documentation of the results may be initiated at the client remote access application 121A, 121B, 121C or 121N through a control activated by the remote healthcare professional. For example, the remote healthcare professional may document the results by selecting a menu option, a button, etc. The client remote access application 121A, 121B, 121C or 121N then sends the results to the server remote access application 111B, which may then communicate the results to, e.g., the application programs 107A/107B.

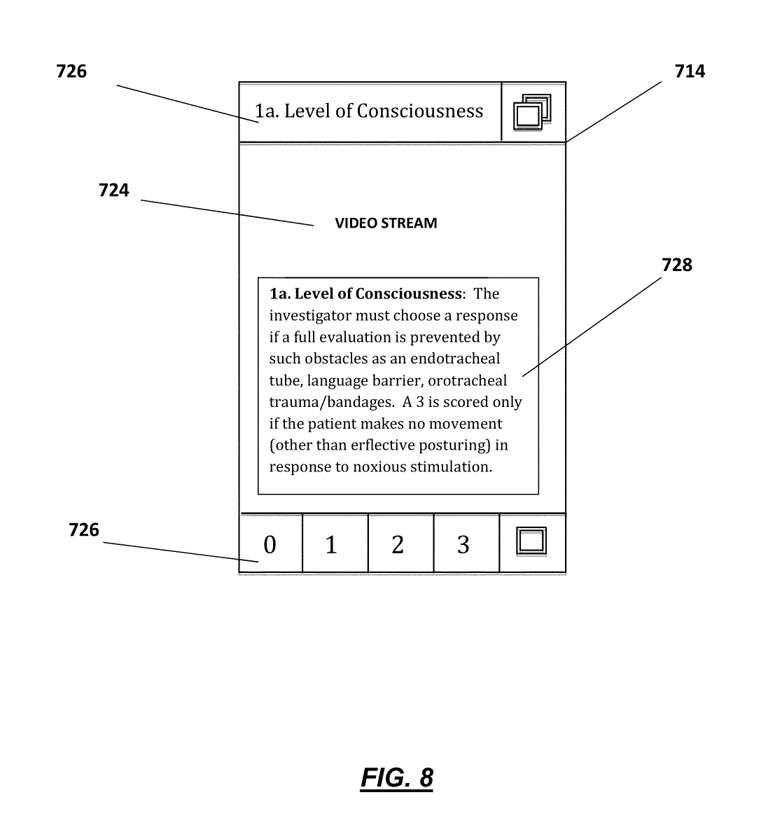

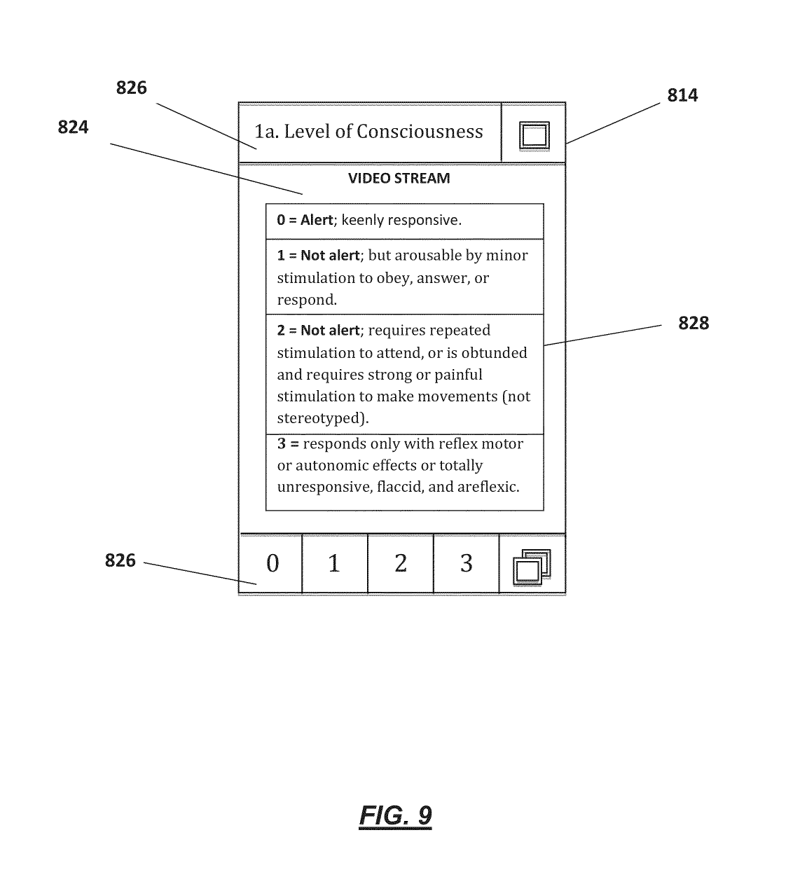

FIGS. 8 and 9 illustrate second and third exemplary graphical displays 714 and 814 of a handheld device, respectively. The graphical displays 714 and 814 include a reference component 728 or 828 in addition to a video component 724 or 824 and a scoring component 726 or 826. In order to efficiently utilize the graphical displays 714 and 814 and simplify workflow, the remote healthcare professional is initially presented with terse information (i.e., only video and scoring components). However, more detailed information is available when needed. The reference component 728 or 828 may be presented as a slide-out, pop-up, etc., for example. As shown in FIG. 8, the reference component 728 includes detailed information regarding the aspect of brain function being measured. As shown in FIG. 9, the reference component includes detailed information regarding scoring of the aspect of brain function being measured.

FIG. 10 illustrates a fourth exemplary graphical display 914 of a handheld device. As discussed above, at the conclusion of the collaborative consultation, a summary report 930 including the final stroke scale score is automatically generated. The summary report may include the score for each item of the stroke scale and the final stroke scale score. The summary report can also include the recorded collaborative consultations. In addition, the healthcare professional may submit the summary report for storage in the patient record within appropriate medical archives and to facilitate billing through a control activated by the remote healthcare professional.

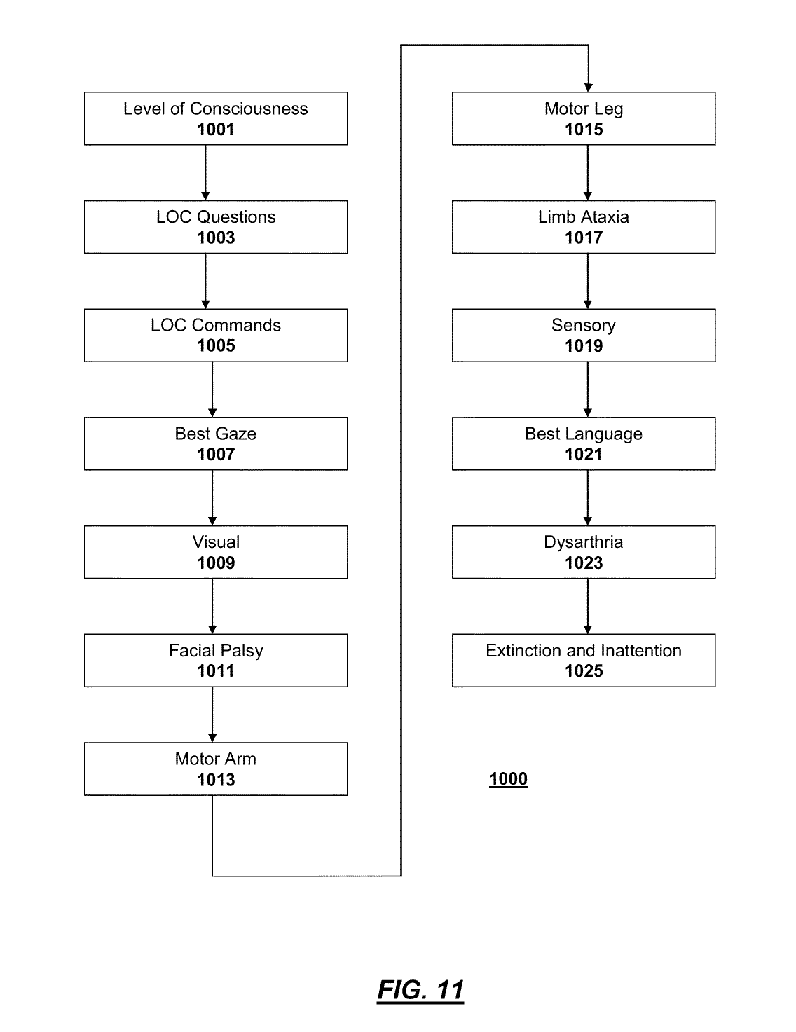

FIG. 11 illustrates an exemplary workflow 1000 of the NIHSS. As discussed above, the NIHSS has proven to be a valid and reliable measure of stroke severity. The NIHSS measures thirteen aspects of brain function, including consciousness, vision, sensation, movement, speech and language. In one implementation, each aspect of brain function is sequentially presented on the client computing device 112A, 112B, 112C or 112N to the healthcare professional during administration of the stroke scale concurrently with a video stream of the patient. At 1001, the healthcare professional measures level of consciousness by choosing a response if a full evaluation is prevented by such obstacles as an endotracheal tube, language barrier, orotracheal trauma/bandages. A “3” is scored only if the patient makes no movement (other than reflective posturing) in response to noxious stimulation.

At 1003, the healthcare professional asks the patient the month and his/her age. The answer must be correct, and there is no partial credit for being close. Aphasic and stuporous patients who do not comprehend the questions will score “2.” Patients unable to speak because of endotracheal intubation, orotracheal trauma, severe dysarthria from any cause, language barrier or any other problem not secondary to aphasia are given a “1.” It is important that only the initial answer be graded and that the healthcare professional not “help” the patient with verbal or non-verbal cues.

At 1005, the healthcare professional asks the patient to open and close the eyes and then to grip and release the non-paretic hand. Substitute another one step command if the hands cannot be used. Credit is given if an unequivocal attempt is made but not completed due to weakness. If the patient does not respond to command, the task should be demonstrated to him or her (pantomime), and the result scored (i.e., follows none, one or two commands). Patients with trauma, amputation or other physical impediments should be given suitable one-step commands. Only the first attempt is scored.

At 1007, the healthcare professional measures best gaze. Only horizontal eye movements will be tested. Voluntary or reflexive (oculocephalic) eye movements will be scored, but caloric testing is not done. If the patient has a conjugate deviation of the eyes that can be overcome by voluntary or reflexive activity, the score will be “1.” If a patient has an isolated peripheral nerve paresis (CN III, IV or VI), score a “1.” Gaze is testable in all aphasic patients. Patients with ocular trauma, bandages, pre-existing blindness or other disorder of visual acuity or fields should be tested with reflexive movements, and a choice made by the healthcare professional. Establishing eye contact and then moving about the patient from side to side will occasionally clarify the presence of partial gaze.

At 1009, the healthcare professional measures vision. Visual fields (upper and lower quadrants) are tested by confrontation, using finger counting or visual threat, as appropriate. Patients may be encouraged, but if they look at the side of the moving fingers appropriately, this can be scored as normal. If there is unilateral blindness or enucleation, visual fields in the remaining eye are scored. Score “1” only if a clear-cut asymmetry, including quadrantanopia, is found. If patient is blind from any cause, score “3.” Double simultaneous stimulation is performed at this point. If there is extinction, patient receives a “1,” and the results are used to respond to the extinction and inattention measurement (i.e., 1025 below).

At 1011, the healthcare professional measures facial palsy. The healthcare professional asks, or uses pantomime to encourage, the patient to show teeth or raise eyebrows and close eyes. Score symmetry of grimace in response to noxious stimuli in the poorly responsive or non-comprehending patient. If facial trauma/bandages, orotracheal tube, tape or other physical barriers obscure the face, these should be removed to the extent possible.

At 1013, the healthcare professional measures motor arm. The limb is placed in the appropriate position: extend the arms (palms down) 90 degrees (if sitting) or 45 degrees (if supine). Drift is scored if the arm falls before 10 seconds. The aphasic patient is encouraged using urgency in the voice and pantomime, but not noxious stimulation. Each limb is tested in turn, beginning with the non-paretic arm. Only in the case of amputation or joint fusion at the shoulder, the healthcare professional should record the score as untestable (UN), and clearly write the explanation for this choice.

At 1015, the healthcare professional measures motor leg. The limb is placed in the appropriate position: hold the leg at 30 degrees (always tested supine). Drift is scored if the leg falls before 5 seconds. The aphasic patient is encouraged using urgency in the voice and pantomime, but not noxious stimulation. Each limb is tested in turn, beginning with the non-paretic leg. Only in the case of amputation or joint fusion at the hip, the healthcare professional should record the score as untestable (UN), and clearly write the explanation for this choice.

At 1017, the healthcare professional measures limb ataxia. This item is aimed at finding evidence of a unilateral cerebellar lesion. Test with eyes open. In case of visual defect, ensure testing is done in intact visual field. The finger-nose-finger and heel-shin tests are performed on both sides, and ataxia is scored only if present out of proportion to weakness. Ataxia is absent in the patient who cannot understand or is paralyzed. Only in the case of amputation or joint fusion, the healthcare professional should record the score as untestable (UN), and clearly write the explanation for this choice. In case of blindness, test by having the patient touch nose from extended arm position.

At 1019, the healthcare professional measures sensation. Sensation or grimace to pinprick when tested, or withdrawal from noxious stimulus in the obtunded or aphasic patient. Only sensory loss attributed to stroke is scored as abnormal and the healthcare professional should test as many body areas (arms [not hands], legs, trunk, face) as needed to accurately check for hemisensory loss. A score of “2,” “severe or total sensory loss,” should only be given when a severe or total loss of sensation can be clearly demonstrated. Stuporous and aphasic patients will, therefore, probably score “1 or 0.” The patient with brainstem stroke who has bilateral loss of sensation is scored “2.” If the patient does not respond and is quadriplegic, score “2.” Patients in a coma (level of consciousness questions 1003=“3”) are automatically given a “2” on this item.

At 1021, the healthcare professional measures best language. A great deal of information about comprehension will be obtained during the preceding sections of the examination. For this scale item, the patient is asked to describe what is happening in the attached picture, to name the items on the attached naming sheet and to read from the attached list of sentences. Comprehension is judged from responses here, as well as to all of the commands in the preceding general neurological exam. If visual loss interferes with the tests, ask the patient to identify objects placed in the hand, repeat and produce speech. The intubated patient should be asked to write. The patient in a coma (level of consciousness questions 1003=“3”) will automatically score “3” on this item. The healthcare professional must choose a score for the patient with stupor or limited cooperation, but a score of “3” should be used only if the patient is mute and follows no one-step commands.

At 1023, the healthcare professional measures dysarthria. If patient is thought to be normal, an adequate sample of speech must be obtained by asking patient to read or repeat words from the attached list. If the patient has severe aphasia, the clarity of articulation of spontaneous speech can be rated. Only if the patient is intubated or has other physical barriers to producing speech, the healthcare professional should record the score as untestable (UN), and clearly write an explanation for this choice. Do not tell the patient why he or she is being tested.

At 1025, the healthcare professional measures extinction and inattention. Sufficient information to identify neglect may be obtained during the prior testing. If the patient has a severe visual loss preventing visual double simultaneous stimulation, and the cutaneous stimuli are normal, the score is normal. If the patient has aphasia but does appear to attend to both sides, the score is normal. The presence of visual spatial neglect or anosagnosia may also be taken as evidence of abnormality. Since the abnormality is scored only if present, the item is never untestable.

As discussed above, each aspect of brain function is sequentially presented on the client computing device 112A, 112B, 112C or 112N to the healthcare professional during administration of the stroke scale. Before moving to the next aspect, the healthcare professional may initiate documentation of the results (i.e., score each aspect of brain function) at the client remote access application 121A, 121B, 121C or 121N through a user-activated control. The client remote access application 121A, 121B, 121C or 121N then sends the results to the server remote access application 111B, which may then communicate the results to, e.g., the application programs 107A/107B. In addition, a summary report 930 including the final stroke scale score may be automatically generated at the conclusion of administration of the stroke scale.

Although the implementations have been described for use with the NIHSS stroke scale, one skilled in the art would understand that the modified NIHSS, Canadian Neurological Scale, Middle Cerebral Artery Neurological Scale or any other stroke scale requiring video conferencing capability for remote administration may be substituted.

FIG. 12 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 12, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 12 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 12 by removable storage 1108 and non-removable storage 1110.

Computing device 1100 typically includes a variety of computer readable media. Computer readable media can be any available media that can be accessed by device 1100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communications connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for remotely administering a scored diagnostic test on a mobile device including a graphical display, comprising:
providing a scoring component of the scored diagnostic test on the graphical display of the mobile device; and
providing a video component of the scored diagnostic test on the graphical display of the mobile device.

2. The method of claim 1, the scoring component and the video component being provided concurrently on the graphical display of the mobile device.

3. The method of claim 1, the scoring component including a plurality of scoring factors.

4. The method of claim 3, the scored diagnostic test being a stroke scale.

5. The method of claim 4, the plurality of scoring factors including at least one of level of consciousness, LOC questions, LOC commands, best gaze, visual, facial palsy, motor arm, motor leg, limb ataxia, sensory, best language, dysarthria and extinction and inattention.

6. The method of claim 3, further comprising sequentially providing each of the plurality of scoring factors on the graphical display of the mobile device.

7. The method of claim 1, further comprising:
providing a scored diagnostic test application; and
providing a server by which the mobile device communicates with the scored diagnostic test application.

8. The method of claim 7, further comprising initiating remote administration of the scored diagnostic test by sending a message from the server to the mobile device.

9. The method of claim 8, the message including a URL.

10. The method of claim 1, further comprising inputting a result of the remote administration of the scored diagnostic test using the scoring component provided on the graphical display of the mobile device.

11. The method of claim 3, further comprising providing a reference component on the graphical display of the mobile device, the reference component including information related to at least one of the plurality of scoring factors.

12. The method of claim 4, the stroke scale being the National Institutes of Health Stroke Scale.

13. The method of claim 1, further comprising generating a summary report of the remote administration of the scored diagnostic test.

14. The method of claim 1, further comprising recording the remote administration of the scored diagnostic test.

15. The method of claim 13, further comprising submitting the summary report for storage in a patient record and/or for billing.

16. A mobile device for remote administration and scoring of a scored diagnostic test, comprising:
a graphical display for displaying a user interface including:
an area for displaying a scoring component of the scored diagnostic test; and
an area for displaying a video component of the scored diagnostic test.

17. The device of claim 16, the scoring component and the video component being displayed concurrently on the user interface of the graphical display.

18. The device of claim 16, the user interface being configured to allow a user to input a result of the remote administration of the scored diagnostic test in the area for displaying the scoring component.

19. A method for providing a user interface for remotely administering a scored diagnostic test, comprising:
providing an area for displaying a scoring component of the scored diagnostic test; and
providing an area for displaying a video component of the scored diagnostic test.

20. The method of claim 19, the scoring component and the video component being displayed concurrently.
